(19) United States
(12) Patent Application Publication
(10) Pub. No.: US 2024/0129111 A1
(43) Pub. Date: Apr. 18, 2024

(54) KEY EXCHANGE SYSTEM, TERMINAL, SERVER, KEY EXCHANGE METHOD, AND PROGRAM

(71) Applicant: NIPPON TELEGRAPH AND TELEPHONE CORPORATION, Tokyo (JP)

(72) Inventors: Yuki OKANO, Tokyo (JP); Tetsutaro KOBAYASHI, Tokyo (JP); Keizo MURAKAMI, Tokyo (JP); Tetsuya OKUDA, Tokyo (JP)

(21) Appl. No.: 18/555,610

(22) PCT Filed: May 19, 2021
(86) PCT No.: PCT/JP2021/019017

§ 371 Date: Oct. 16, 2023

(51) Int. Cl. H04L 9/08; H04L 9/06; H04L 9/32

(52) U.S. Cl. CPC H04L 9/0819; H04L 9/06; H04L 9/3213

(57) ABSTRACT

A key exchange system according to an embodiment includes: a plurality of terminals that perform key exchange; and a server that performs authentication of each of the terminals and mediation of the key exchange, in which the server includes a nonce generation unit that generates a nonce used when the authentication is performed between the server and the terminal by federation using OpenID Connect, a key generation unit that generates a public key and a secret key of token control encryption, a first transmission unit that transmits the nonce and the public key to the terminal, and a decryption unit that decrypts a ciphertext received from the terminal by using the secret key and a token received from the terminal, and the terminal includes an encryption unit that generates a ciphertext obtained by encrypting predetermined data by using the public key and a token generated from the nonce, a second transmission unit that transmits the ciphertext to the server, and a long-term secret string generation unit that generates a long-term secret string for use in the key exchange, by using the nonce.

### TECHNICAL FIELD

The present invention relates to a key exchange system, a terminal, a server, a key exchange method, and a program.

### BACKGROUND ART

In order to enable secret communication between a large number of terminals, a technology called a multi-party key exchange protocol for exchanging a shared key (session key) used for encryption/decryption of the secret communication is known (for example, Non Patent Literatures 1 and 2, and the like). The protocols disclosed in Non Patent Literatures 1 and 2 are server-assisted key exchange protocols, and are technologies for sharing a session key among a plurality of terminals via a server.

In the technologies disclosed in Non Patent Literatures 1 and 2, it is necessary to manage a plurality of keys in a terminal in order to satisfy security such as forward secrecy and short-term secret key leakage resistance. Specifically, it is necessary to manage a secret key of public key encryption or a secret key of attribute-based encryption and a long-term secret string as a long-term secret key, and manage a short-term secret string as a short-term secret key. In particular, the long-term secret key should be semi-permanently managed by the terminal. Here, the forward secrecy means that the past communication content is still safe even if the long-term secret key is leaked, and the short-term secret key leakage resistance means that the key shared in the session is still safe even if the random number generator that generates the random number used unique to the key exchange session is vulnerable (that is, in a case where there is predictability in the output of the random number generator).

### CITATION LIST

### Non Patent Literature

Non Patent Literature 1: Kazuki Yoneyama, Reo Yoshida, Yuto Kawahara, Tetsutaro Kobayashi, Hitoshi Fuji, Tomohide Yamamoto, “Multi-Cast Key Distribution: Scalable, Dynamic and Provably Secure Construction,” International Conference on Provable Security (ProvSec 2016), LNCS10005, pp. 207-226, November 2016.
Non Patent Literature 2: Yoneyama, Kazuki, et al. “Exposure-Resilient Identity-Based Dynamic Multi-Cast Key Distribution.” IEICE TRANSACTIONS on Fundamentals of Electronics, Communications and Computer Sciences 101.6 (2018): 929-944.

### SUMMARY OF INVENTION

### Technical Problem

However, in the technologies disclosed in Non Patent Literatures 1 and 2, in a case where key exchange is performed on a plurality of unspecified terminals using one user account, it is necessary to store a long-term secret key associated with the user account in the terminal in advance. In addition, it is necessary to delete the long-term secret key from the unnecessary terminal. As described above, in a case where key exchange is performed on a plurality of unspecified terminals using one user account, there is a problem that the operation and management cost of the long-term secret key increases. In view of this problem, by combining a federation protocol called OpenID Connect (hereinafter, also referred to as “OIDC”), it is considered that a scheme in which a terminal does not need to have a secret key of public key encryption or a secret key of attribute-based encryption can be adopted. In addition, it is considered that it is possible to adopt a scheme in which it is not necessary to semi-permanently have the long-term secret string.

The simplest way to adopt a scheme in which it is not necessary to semi-permanently have the long-term secret string is to generate the long-term secret string at the terminal each time the key exchange protocol is performed. On the other hand, since the long-term secret string and the short-term secret string are generated by the same random number generator, both strings are leaked when the random number generator is vulnerable, and the short-term secret key leakage resistance cannot be satisfied. For this reason, the long-term secret string and the short-term secret string each need to be generated from different random number generators.

An embodiment of the present invention has been made in view of the above points, and an object thereof is to implement server-assisted key exchange with reduced operation and management cost of a long-term secret key.

### Solution to Problem

In order to achieve the above object, a key exchange system according to an embodiment includes: a plurality of terminals that perform key exchange; and a server that performs authentication of each of the terminals and mediation of the key exchange, in which the server includes a nonce generation unit that generates a nonce used when the authentication is performed between the server and the terminal by federation using OpenID Connect, a key generation unit that generates a public key and a secret key of token control encryption, a first transmission unit that transmits the nonce and the public key to the terminal, and a decryption unit that decrypts a ciphertext received from the terminal by using the secret key and a token received from the terminal, and the terminal includes an encryption unit that generates a ciphertext obtained by encrypting predetermined data by using the public key and a token generated from the nonce, a second transmission unit that transmits the ciphertext to the server, and a long-term secret string generation unit that generates a long-term secret string for use in the key exchange, by using the nonce.

### Advantageous Effects of Invention

It is possible to achieve server-assisted key exchange with reduced operation and management cost of a long-term secret key.

### BRIEF DESCRIPTION OF DRAWINGS

FIG. 1 is a diagram illustrating an example overall configuration of a key exchange system according to the present embodiment.

FIG. 2 is a diagram illustrating an example of a functional configuration of the terminal according to the present embodiment.

FIG. 3 is a diagram illustrating an example of a functional configuration of the server according to the present embodiment.

FIG. 4 is a sequence diagram illustrating an example of federation (implicit flow) and key exchange processing according to the present embodiment.

FIG. 5 is a sequence diagram illustrating an example of federation (authorization code flow) and key exchange processing according to the present embodiment.

FIG. 6 is a diagram illustrating an example of a hardware configuration of a computer.

### DESCRIPTION OF EMBODIMENTS

Hereinafter, an embodiment of the present invention will be described. In the present embodiment, a key exchange system 1 capable of achieving server-assisted key exchange with reduced operation and management cost of a long-term secret key by combining OIDC will be described. The technology disclosed in Non Patent Literature 1 or 2 is assumed as the server-assisted key exchange. For IDC, see, for example, Reference Document 1 “OpenID Connect Core 1.0 incorporating errata set 1, Internet <URL: http://openid-foundation-japan. github.io/openid-connect-core-1_0.ja.html>” and the like.

<Preparation>

First, an encryption scheme and a function used in the present embodiment are prepared.

<<Public Key Encryption>>

Public key encryption is composed of the following set of three algorithms (KeyGen, Enc, Dec).

KeyGen (1^{κ})→(pk, sk): A key generation algorithm that receives a one-bit string 1^{κ} of a security parameter κ length as an input and outputs a key pair (pk, sk) of a public key pk and a secret key sk.

Enc (pk, m)→C: An encryption algorithm that receives the public key pk and a message m as inputs and outputs a ciphertext C.

Dec (sk, C)→m′: A decryption algorithm that receives the secret key sk and the ciphertext C as inputs and outputs a message m′.

The public key encryption also requires the following conditions as validity.

Validity condition: For any security parameter κ, any key pair (pk, sk)←KeyGen (1^{κ}), and any message m, Dec (sk, Enc (pk, m))=m holds.

<<Token Control Public Key Encryption>>

Token control public key encryption is composed of the following set of three algorithms (TKeyGen, TEnc, TDec).

TKeyGen (1^{κ})→(pk, sk): A key generation algorithm that receives a one-bit string 1^{κ} of a security parameter κ length as an input and outputs a key pair (pk, sk) of a public key pk and a secret key sk.

TEnc (pk, m, token)→C: An encryption algorithm that receives the public key pk, the message m, and a token token as inputs and outputs the ciphertext C.

TDec (sk, C, token)→m′: A decryption algorithm that receives the secret key sk, the ciphertext C, and the token token as inputs and outputs the message m′.

The token control public key encryption also requires the following conditions as validity.

Validity condition: For any security parameter κ, any key pair (pk, sk)←TKeyGen (1^{κ}), any token token, and any message m, TDec (sk, TEnc (pk, m, token))=m holds.

Examples of token control public key encryption include an encryption scheme described in Reference Document 2 “Galindo, David, and Javier Herranz. “A generic construction for tokencontrolled public key encryption.” International Conference on Financial Cryptography and Data Security. Springer, Berlin, Heidelberg, 2006.”.

<<Key Derivation Function>>

A key derivation function KDF (x, s) is a function that receives a character string x and a salt s as inputs and outputs a key K. An output K for an arbitrary character string x is a function that is computationally difficult to identify from a key K′ uniformly and randomly extracted from the same key space.

Examples of the key derivation function include PBKDF2 disclosed in Reference Document 3 Moriarty, K. M., B. Kaliski, and Andreas Rusch. “RFC 8018: PKCS #5: Password-Based Cryptography Specification Version 2.1.” Internet Activities Board (2017).”.

<<Pseudo Random Function>>

The pseudo random function PRF (k, s) is a function that receives the key k and the character string s as inputs and outputs the key K, and is a function in which the output of the PRF and the output of an arbitrary function having the same domain as the input on the right side of the PRF and having the same value range as the PRF are computationally difficult to identify.

Examples of the pseudo-random function include HMAC disclosed in Reference Document 4 “Krawczyk, Hugo, Mihir Bellare, and Ran Canetti. “RFC2104: HMAC: Keyed-hashing for message authentication.” (1997).”.

<Overall Configuration>

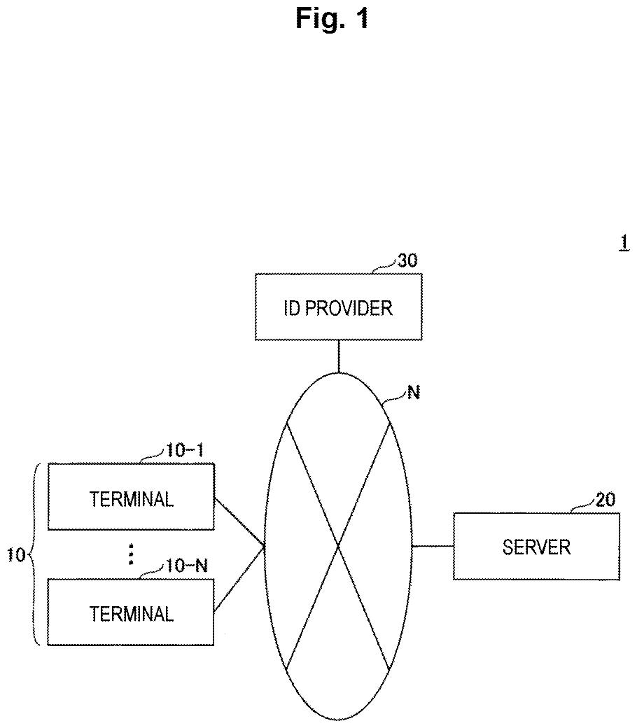

Next, an overall configuration of the key exchange system 1 according to the present embodiment will be described with reference to FIG. 1. FIG. 1 is a diagram illustrating an example overall configuration of the key exchange system 1 according to the present embodiment.

As illustrated in FIG. 1, the key exchange system 1 according to the present embodiment includes a plurality of terminals 10, a server 20, and an ID provider 30. These are communicably connected via a communication network N such as the Internet. Hereinafter, each of the terminals 10 that perform key exchange is referred to as a “terminal 10-1”, . . . , and a “terminal 10-N”. Here, N (where N≥2) is the total number of terminals.

The terminal 10 is a user terminal that performs key exchange with one or more other terminals 10 using a server-assisted key exchange protocol. Examples of the terminal 10 include various apparatuses and devices such as a general-purpose server, a personal computer (PC), a smartphone, a tablet terminal, a wearable device, an in-vehicle device, an industrial device, a home appliance, and a robot.

The server 20 is a server that supports key exchange when the key exchange is performed between the plurality of terminals 10 by a server-assisted key exchange protocol (that is, mediates the key exchange between the plurality of terminals 10). Here, when key exchange is performed among the plurality of terminals 10, the server 20 needs to authenticate (signature verification, encryption, or the like) each of the terminals 10. In the present embodiment, this authentication is performed by token control public key encryption using a nonce used in OIDC as a token, and a long-term secret string is generated from the nonce. As a result, each terminal 10 does not need to have the secret key of the public key encryption or the secret key of the attribute-based encryption, and does not need to semi-persistently possess the long-term secret string. Accordingly, server-assisted key exchange with reduced operation and management cost of a long-term secret key.

In addition to the above, in the present embodiment, each terminal 10 can be authenticated by an arbitrary authentication scheme requested by the OP, and authentication can be performed by token control public key encryption using the same nonce within the valid period of the ID token of the OIDC (alternatively, within a valid period designated by the server 20). Therefore, it is not necessary to perform re-authentication at the time of executing each key exchange session within the valid period.

The ID provider 30 is a server or the like that functions as an OpenID Provider (OP) of the OIDC. The ID provider 30 requests the terminal 10 to perform user authentication according to a predetermined arbitrary authentication scheme.

<Functional Configuration>

Next, a functional configuration of the terminal 10 and the server 20 according to the present embodiment will be described.

<<Terminal 10>>

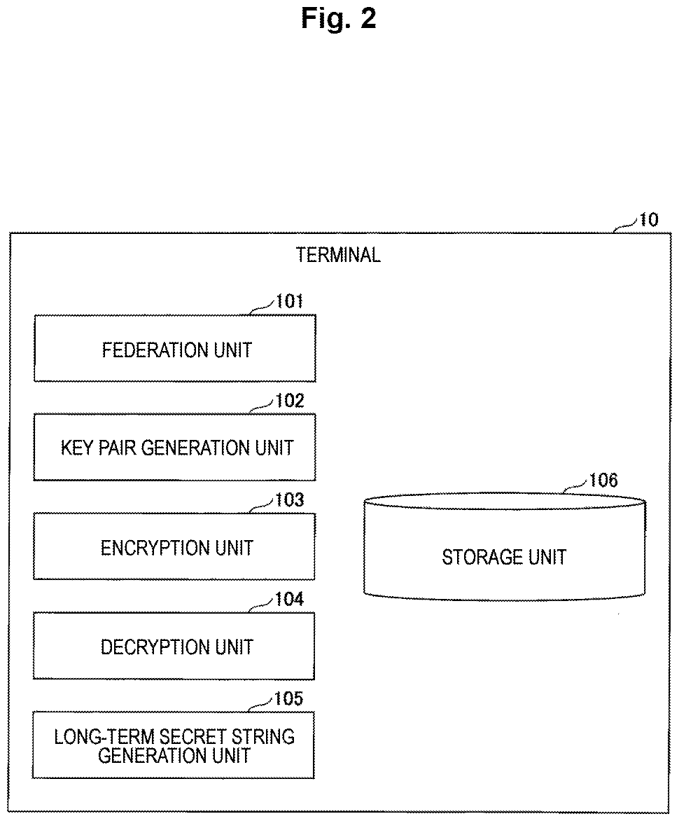

A functional configuration of the terminal 10 according to the present embodiment will be described with reference to FIG. 2. FIG. 2 is a diagram illustrating an example of a functional configuration of the terminal 10 according to the present embodiment.

As illustrated in FIG. 2, the terminal 10 according to the present embodiment includes a federation unit 101, a key pair generation unit 102, an encryption unit 103, a decryption unit 104, and a long-term secret string generation unit 105. For example, each unit is implemented by a processor such as a central processing unit (CPU) executes one or more programs installed in the terminal 10.

In addition, the terminal 10 according to the present embodiment includes a storage unit 106. The storage unit 106 is implemented by, for example, various memory devices such as a hard disk drive (HDD), a solid state drive (SSD), or flash memory.

The federation unit 101 performs various processes for performing federation by the OIDC. The key pair generation unit 102 executes the key generation algorithm KeyGen to generate a key pair of own public key and secret key of the terminal 10. The encryption unit 103 executes the encryption algorithm TEnc using the hash value of the nonce used in the OIDC as a token to generate a ciphertext. The decryption unit 104 executes the decryption algorithm Dec to decrypt the ciphertext. The long-term secret string generation unit 105 generates a long-term secret string from a nonce used in the OIDC. The storage unit 106 stores information necessary for each of the above units to execute various processes, execution results thereof, and the like (for example, various keys, nonce, ID token, or long-term secret string).

<<Server 20>>

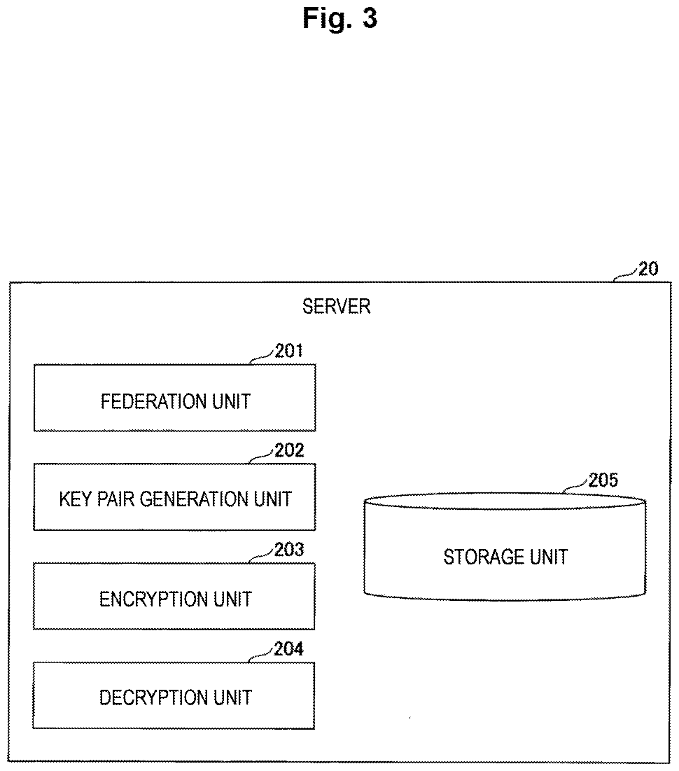

A functional configuration of the server 20 according to the present embodiment will be described with reference to FIG. 3. FIG. 3 is a diagram illustrating an example of a functional configuration of the server 20 according to the present embodiment.

As illustrated in FIG. 3, the server 20 according to the present embodiment includes a federation unit 201, a key pair generation unit 202, an encryption unit 203, and a decryption unit 204. Each of these units is implemented, for example, by processing executed by the processor such as a CPU by one or more programs installed in the server 20.

In addition, the server 20 according to the present embodiment includes a storage unit 205. The storage unit 205 is implemented by, for example, various memory devices such as an HDD, an SSD, and a flash memory. The storage unit 205 may be implemented by, for example, a storage device connected to the server 20 via the communication network.

The federation unit 201 performs various processes for performing federation by the OIDC. In particular, the federation unit 201 generates a nonce used in the OIDC. The key pair generation unit 202 executes the key generation algorithm TKeyGen to generate a key pair of public key and secret key of the server. The encryption unit 203 executes the encryption algorithm Enc to generate a ciphertext. The decryption unit 204 executes the decryption algorithm TDec to decrypt the ciphertext. At this time, the decryption unit 204 decrypts the ciphertext by using the hash value of the nonce generated by the server 20. The storage unit 205 stores information necessary for each of the above units to execute various processes, execution results thereof, and the like (for example, various keys, nonce, or ID token).

<Federation and Key Exchange Processing>

Hereinafter, the federation and the key exchange processing according to the present embodiment will be described. Here, in the server-assisted key exchange protocol disclosed in Non Patent Literatures 1 and 2, as described above, the secret key of public key encryption or attribute-based encryption and the long-term secret strings st and st′ exist as the long-term secret key held by each terminal 10. These long-term secret strings, along with the short-term secret strings generated in each phase, are used to input a twisted pseudo-random function in a Dist/Join/Leave phase. In Non Patent Literature 1, the secret key of public key encryption and the long-term secret strings st and st′ are long-term secret keys, and in Non Patent Literature 2, the secret key of attribute-based encryption and the long-term secret strings st and st′ are long-term secret keys.

Although the above-described long-term secret strings st and st′ are generated at each terminal 10 at the time of setup, in the present embodiment, these long-term secret strings st and st′ are generated from the nonce. Therefore, each terminal 10 does not semi-permanently hold the long-term secret strings st and st′, but regenerates the long-term secret strings st and st′ every valid period (alternatively, the valid period designated by the server 20) of the ID token of the OIDC, and holds the long-term secret strings st and st′ only during the period. However, the long-term secret strings st and st′ generated once may be semi-permanently held.

In the OIDC, there are an authentication flow called an implicit flow and an authentication flow called an authorization code flow. Therefore, a case where the authentication flow is the implicit flow and a case where the authentication flow is the authorization code flow will be described below. When the authentication flow is an implicit flow, the terminal 10 and the server 20 correspond to a relying party (RP), and when the authentication flow is an authorization code flow, the server 20 corresponds to the RP.

<<Case where Federation is Implicit Flow>>

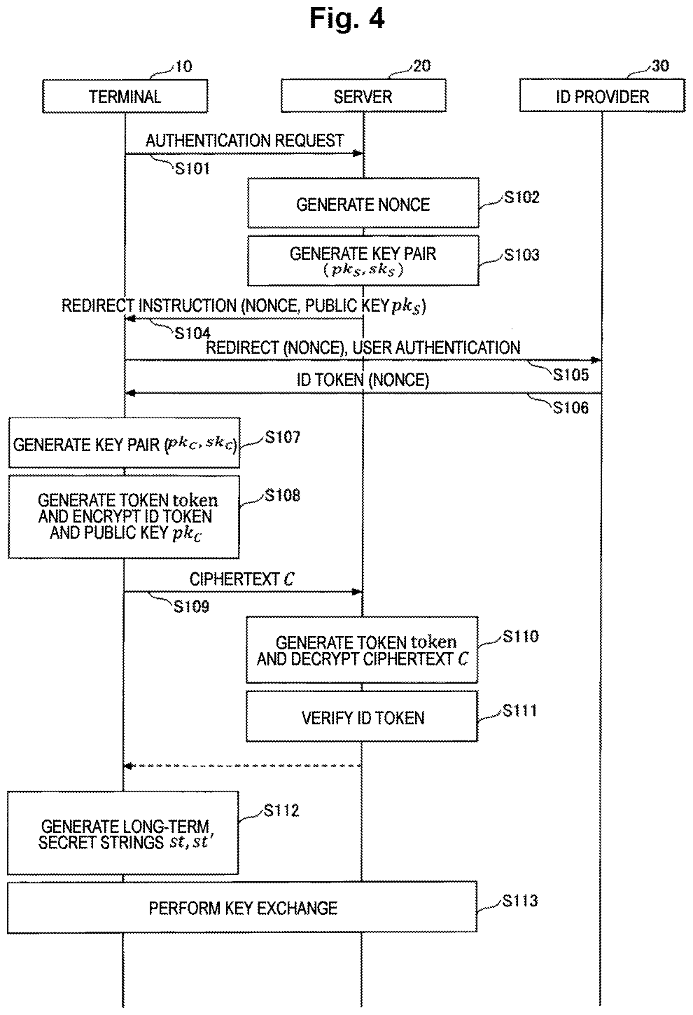

The federation and the key exchange processing when the authentication flow is the implicit flow will be described with reference to FIG. 4. FIG. 4 is a sequence diagram illustrating an example of federation (implicit flow) and key exchange processing according to the present embodiment.

The federation unit 101 of the terminal 10 transmits an authentication request to the server 20 (step S101).

Upon receiving the authentication request, the federation unit 201 of the server 20 generates a nonce nonce used in the OIDC (step S102). The key pair generation unit 202 of the server 20 generates a key pair (pk_{S}, sk_{S}) of the public key pk_{S} and the secret key sk_{S} by TKeyGen (1^{κ})→(pk_{S}, sk_{S}) (step S103). Subsequently, the federation unit 201 of the server 20 transmits a redirection instruction to the ID provider 30 to the terminal 10 (step S104). At this time, the federation unit 201 includes the nonce nonce and the public key pk_{S} in the redirection instruction.

Upon receiving the redirection instruction, the federation unit 101 of the terminal 10 redirects to the ID provider 30, and performs user authentication by the authentication scheme requested by the ID provider 30 (step S105). At this time, the federation unit 101 transmits the nonce nonce to the ID provider 30 at the time of user authentication. Examples of the authentication method requested by the ID provider 30 include various authentication methods such as “ID/password”, “SMS authentication”, “fingerprint authentication”, and “multi-factor authentication”.

In a case where the user authentication described above is successful, an ID token with a signature and a nonce by the ID provider 30 is returned from the ID provider 30 to the terminal 10 (step S106).

Upon receiving the ID token from the ID provider 30, the key pair generation unit 102 of the terminal 10 generates a key pair (pk_{C}, sk_{C}) of the public key pk_{C} and the secret key sk_{C} by KeyGen (1^{κ})→(pk_{C}, sk_{C}) (step S107). Next, the encryption unit 103 of the terminal 10 generates a ciphertext C obtained by encrypting the message m including the ID token and the public key pk_{C} with the public key pk_{S} using the hash value obtained by inputting the nonce nonce to a predetermined hash function (for example, SHA-256 or the like) as the token token (step S108). That is, the encryption unit 103 generates the ciphertext C by TEnc (pk_{S}, m, token)→C. Then, the encryption unit 103 of the terminal 10 transmits the ciphertext C to the server 20 (step S109).

Upon receiving the ciphertext C, the decryption unit 204 of the server 20 decrypts the ciphertext C with the secret key sk_{S} using a hash value obtained by inputting the nonce nonce to a predetermined hash function (for example, SHA-256 or the like) as the token token (step S110). That is, the decryption unit 204 decrypts the ciphertext C using TDec (sk_{S}, C, token)→m to obtain the message m. As a result, the ID token and the public key pk_{C} are obtained from the message m.

The federation unit 201 of the server 20 verifies the ID token obtained in step S110 (step S111). That is, after verifying the signature of the ID token, the federation unit 201 verifies that the nonce given to the ID token matches the nonce nonce generated in step S102 described above.

Subsequently, in a case where the verification in step S111 described above is successful, the long-term secret string generation unit 105 of the terminal 10 generates the long-term secret strings st and st′ from the nonce nonce by any of the following Method 1 or Method 2 (step S112).

Method 1: Set the output of the key derivation function KDF with the nonce nonce and the salt as inputs as the long-term secret string. That is, the long-term secret strings st and st′ are generated by st=KDF (nonce, s) and st′=KDF (nonce, s′) with the two salts as s and s′. The salts s and s′ may be, for example, s=‘0001’, s′=‘0002’, or the like.

Method 2: Set the output of the pseudo-random function PRF with the nonce nonce and the string as inputs as the long-term secret string. That is, the long-term secret strings st and st′ are generated by st=PRF (nonce, s) and st′=PRF (nonce, s′) with the two strings as s and s′. The strings s and s′ may be, for example, s=‘0001’, s′=‘0002’, or the like.

As described above, by generating the long-term secret string from the random number (that is, the nonce nonce) generated from the random number generator different from the random number generator used in the terminal 10, the long-term secret string is not leaked even if the random number generator of the terminal 10 is vulnerable, so that the secure key exchange can be achieved. In addition, since the nonce nonce of the OIDC is used, it is not necessary to perform extra communication or calculation for generating the long-term secret string, and it is possible to efficiently generate the long-term secret string.

In a case where the long-term secret strings st and st′ are generated in step S112 described above, the terminal 10 and the server 20 perform key exchange (step S113). Details of this key exchange will be described later.

<<Case where Federation is Authorization Code Flow>>

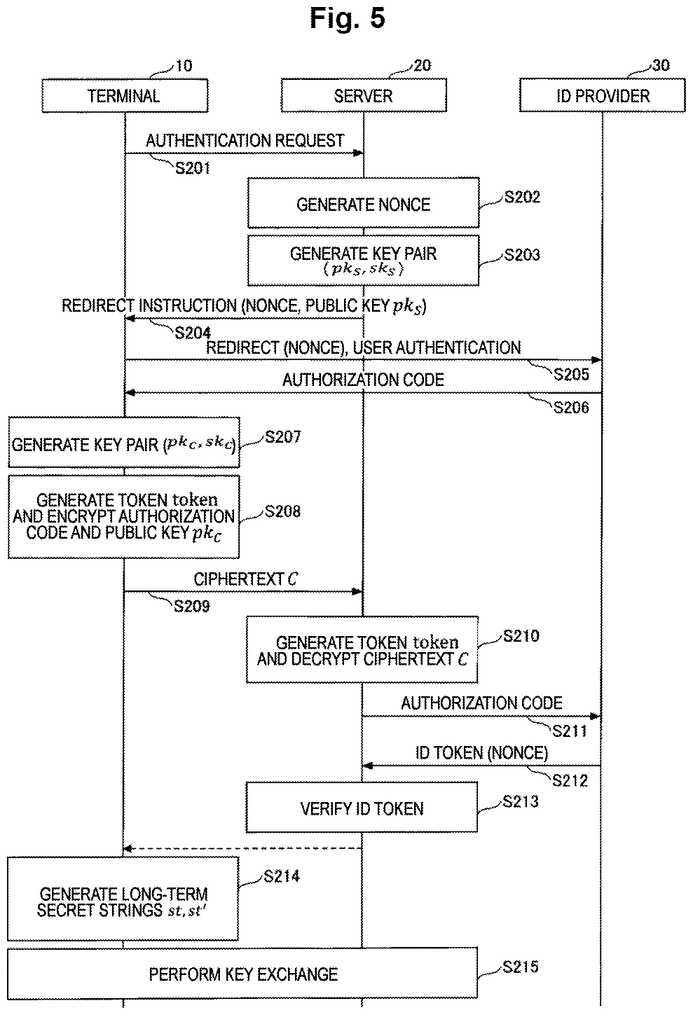

The federation and the key exchange processing when the federation is the authorization code flow will be described with reference to FIG. 5. FIG. 5 is a sequence diagram illustrating an example of federation (authorization code flow) and key exchange processing according to the present embodiment.

The federation unit 101 of the terminal 10 transmits an authentication request to the server 20 (step S201).

Upon receiving the authentication request, the federation unit 201 of the server 20 generates a nonce nonce used in the OIDC (step S202). The key pair generation unit 202 of the server 20 generates a key pair (pk_{S}, sk_{S}) of the public key pk_{S} and the secret key sk_{S} by TKeyGen (1^{κ})→(pk_{S}, sk_{S}) (step S203). Subsequently, the federation unit 201 of the server 20 transmits a redirection instruction to the ID provider 30 to the terminal 10 (step S204). At this time, the federation unit 201 includes the nonce nonce and the public key pk_{S} in the redirection instruction.

Upon receiving the redirection instruction, the federation unit 101 of the terminal 10 redirects to the ID provider 30, and performs user authentication by the authentication scheme requested by the ID provider 30 (step S205). At this time, the federation unit 101 transmits the nonce nonce to the ID provider 30 at the time of user authentication.

In a case where the user authentication described above is successful, an authorization code is returned from the ID provider 30 to the terminal 10 (step S206).

Upon receiving the authorization code from the ID provider 30, the key pair generation unit 102 of the terminal 10 generates a key pair (pk_{C}, sk_{C}) of the public key pk_{C} and the secret key sk_{C} by KeyGen (1^{κ})→(pk_{C}, sk_{C}) (step S207). Next, the encryption unit 103 of the terminal 10 generates a ciphertext C obtained by encrypting the message m including the authorization code and the public key pk_{C} with the public key pk_{S} using the hash value obtained by inputting the nonce nonce to a predetermined hash function (for example, SHA-256 or the like) as the token token (step S208). That is, the encryption unit 103 generates the ciphertext C by TEnc (pk_{S}, m, token)→C. Then, the encryption unit 103 of the terminal 10 transmits the ciphertext C to the server 20 (step S209).

Upon receiving the ciphertext C, the decryption unit 204 of the server 20 decrypts the ciphertext C with the secret key sk_{S} using a hash value obtained by inputting the nonce nonce to a predetermined hash function (for example, SHA-256 or the like) as the token token (step S210). That is, the decryption unit 204 decrypts the ciphertext C using TDec (sk_{S}, C, token)→m to obtain the message m. As a result, the authorization code and the public key pk_{C} are obtained from the message m.

Next, the federation unit 201 of the server 20 transmits the authorization code obtained in step S210 to the ID provider 30 (step S211). As a result, an ID token with a signature and a nonce by the ID provider 30 is returned from the ID provider 30 to the server 20 (step S212).

The federation unit 201 of the server 20 verifies the ID token obtained in step S212 (step S213). That is, after verifying the signature of the ID token, the federation unit 201 verifies that the nonce given to the ID token matches the nonce nonce generated in step S202 described above.

Subsequently, in a case where the verification in step S213 described above is successful, as similar to step S112 in FIG. 4, the long-term secret string generation unit 105 of the terminal 10 generates the long-term secret strings st and st′ from the nonce nonce by any of the following Method 1 or Method 2 (step S214).

In a case where the long-term secret strings st and st′ are generated in step S214 described above, the terminal 10 and the server 20 perform key exchange (step S215). Details of this key exchange will be described later.

<<Key Exchange Processing>>

The key exchange in step S113 or step S215 described above will be described. Here, a case where key exchange disclosed in Non Patent Literatures 1 and 2 described above is performed will be described. For processing other than the processing specifically described below, refer to Non Patent Literatures 1 and 2.

In the key exchange disclosed in Non Patent Literatures 1 and 2, first, a MAC key and a key of attribute-based encryption are transmitted from the server 20 to the terminal 10. At this time, the encryption unit 203 of the server 20 generates a ciphertext C obtained by encrypting the message m′ including these keys with the public key pk_{C}, that is, generates the ciphertext C by Enc (pk_{C}, m′)→C, and transmits the ciphertext C to the terminal 10. Then, the decryption unit 104 of the terminal 10 decrypts the ciphertext C, that is, generates a message m′ by Dec (sk_{C}, C)→m′, and extracts the MAC key and the key of the attribute-based encryption from the message m′. Subsequent processing is similar to the processing disclosed in Non Patent Literatures 1 and 2.

<Hardware Configuration>

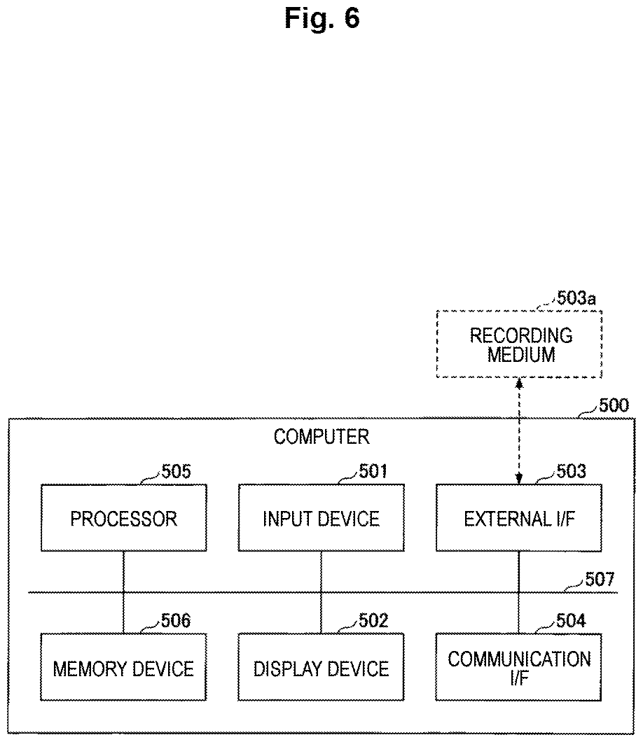

Lastly, a hardware configuration of the terminal 10 and the server 20 according to the present embodiment will be described. The terminal 10 and the server 20 in the present embodiment are implemented by, for example, a hardware configuration of a computer 500 illustrated in FIG. 6. FIG. 6 is a diagram illustrating an example of a hardware configuration of the computer 500.

The computer 500 illustrated in FIG. 6 includes an input device 501, a display device 502, an external I/F 503, a communication I/F 504, a processor 505, and a memory device 506. These pieces of hardware are communicably connected by a bus 507.

The input device 501 is, for example, a keyboard, a mouse, a touch panel, or the like. The display device 502 is, for example, a display or the like. Note that the computer 500 may not include at least one of the input device 501 or the display device 502, for example.

The external I/F 503 is an interface with an external device such as a recording medium 503a. The computer 500 can read or write the recording medium 503a via the external I/F 503. Note that examples of the recording medium 503a include a compact disc (CD), a digital versatile disk (DVD), a secure digital memory card (SD memory card), a universal serial bus (USB) memory card, and the like.

The communication I/F 504 is an interface for connecting the computer 500 to a communication network. The processor 505 is one of various arithmetic devices such as a CPU, for example. The memory device 506 is, for example, a storage device of various types such as a HDD, an SSD, a flash memory, a random access memory (RAM), and a read only memory (ROM).

The terminal 10 and the server 20 according to the present embodiment has the hardware configuration illustrated in FIG. 6, thereby being able to implement the above-described federation and key exchange processing. Note that the hardware configuration illustrated in FIG. 6 is an example, and, for example, the computer 500 may include a plurality of processors or may include a plurality of memory devices, and may include various hardware configurations.

The present invention is not limited to the above embodiment specifically disclosed, and various modifications and changes, combinations with known technologies, and the like can be made without departing from the scope of the claims.

### REFERENCE SIGNS LIST

1 Key exchange system
10 Terminal
20 Server
30 ID provider
101 Federation unit
102 Key pair generation unit
103 Encryption unit
104 Decryption unit
105 Long-term secret string generation unit
106 Storage unit
201 Federation unit
202 Key pair generation unit
203 Encryption unit
204 Decryption unit
205 Storage unit
N Communication network

1. A key exchange system comprising: a plurality of terminals that perform key exchange; and a server that performs authentication of each of the terminals and mediation of the key exchange, wherein
the server is configured to:
generate a nonce used when the authentication is performed between the server and the terminal by federation using OpenID Connect;
generate a public key and a secret key of token control encryption;
transmit the nonce and the public key to the terminal; and
decrypt a ciphertext received from the terminal by using the secret key and a token received from the terminal, and
the terminal is configured to:
generate a ciphertext obtained by encrypting predetermined data by using the public key and a token generated from the nonce;
transmit the ciphertext to the server; and
generate a long-term secret string for use in the key exchange, by using the nonce.

2. The key exchange system according to claim 1, wherein
the terminal generates the long-term secret string by a key derivation function or a pseudo-random function using the nonce as an input.

3. A terminal connected to another terminal that performs key exchange and a server that performs authentication of each terminal and mediation of the key exchange via a communication network, the terminal comprising:
a processor; and
a memory storing program instructions that cause the processor to:
generate a ciphertext obtained by encrypting predetermined data, using a public key of token control encryption and generated by the server, and a token generated from a nonce used when the authentication is performed between the terminal and the server by federation using OpenID Connect;
transmit the ciphertext to the server; and
generate a long-term secret string for use in the key exchange, by using the nonce.

4. (canceled)

5. A key exchange method used in a key exchange system including a plurality of terminals that perform key exchange and a server that performs authentication of each of the terminals and mediation of the key exchange,
the key exchange method comprising steps performed by the server, the steps including:
generating a nonce used when the authentication is performed between the server and the terminal by federation using OpenID Connect;
generating a public key and a secret key of token control encryption:
transmitting the nonce and the public key to the terminal; and
decrypting a ciphertext received from the terminal by using the secret key and a token received from the terminal,
the key exchange method further comprising steps performed by the terminal, the steps including:
generating a ciphertext obtained by encrypting predetermined data by using the public key and a token generated from the nonce;
transmitting the ciphertext to the server; and
generating a long-term secret string for use in the key exchange, by using the nonce.

6. A non-transitory computer-readable recording medium having stored therein a program for causing the plurality of terminals and the server to perform the key exchange method according to claim 5.
